(19) United States
(12) Patent Application Publication
(10) Pub. No.: US 2009/0319180 A1
(43) Pub. Date: Dec. 24, 2009

(54) EMERGENCY RESPONDER GEOGRAPHIC INFORMATION SYSTEM

(76) Inventors: Aaron Thomas Robinson, Durango, CO (US); John Richard Doherty, JR., Charlottesville, VA (US); Albert Koenigsberg, Boca Raton, FL (US); Orval F. Hart, Los Alamos, NM (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/110,475

(22) Filed: Apr. 28, 2008

Related U.S. Application Data
(60) Provisional application No. 60/924,051, filed on Apr. 27, 2007.

(51) Int. Cl. G01C 21/26; G08B 21/00

(52) U.S. Cl. 701/208; 340/540; 701/200

(57) ABSTRACT

Certain embodiments of the present invention are directed to a system for providing a layered map illustrating information associated with an emergency event location during an emergency event. The information can include pre-planning data, map data, and current data. The layered map can be accessed by emergency responders using user devices and administrators or other command center personnel. The information can be used to better respond and manage a response to an emergency event.

### CROSS-REFERENCE TO RELATED APPLICATIONS

This application claims priority to U.S. Provisional Application No. 60/924,051, entitled “Emergency Responder Geographic Information System,” filed Apr. 27, 2007, the entire contents of which is incorporated herein by reference.

### FIELD OF THE INVENTION

The present invention relates generally to communication systems and, specifically, to communication systems to support responding to emergency events.

### BACKGROUND

The advent of the Department of Homeland Security and recent threats to the nation illustrate a need for a comprehensive and well-planned infrastructure for responding to emergency events. Responding to emergency events in a prepared and timely manner is vital for effectively controlling and extinguishing danger or other underlying activity that causes or is produced by an emergency event. Preparedness and timeliness depends, in part, on identifying and managing the appropriate personnel, equipment, and responding within the shortest amount of time possible. These important criteria can be critical for improving capabilities and performance for responding to emergency events and can be promoted or inhibited depending on the infrastructure support provided.

One part of an emergency response infrastructure that can promote or inhibit an effective emergency response is a communications system. Various types of communication systems are available for implementation in an emergency response system. Typically, such communication systems include a centralized command center that receives calls or other outside communication reporting an emergency and contacts the appropriate emergency responders, for example via wireless voice communication, for dispatch to the emergency. The type and amount of information conveyed via such communication systems can be limited. For example, emergency responders often need information associated with the location of the emergency event. The information conveyed via such communication systems may include an address and directions, such as a map. However, additional location information, such as the existence of dangerous obstacles at the emergency event location and accessible equipment for responding to the emergency event (e.g. fire hydrants) at or near the emergency event location may be unavailable or otherwise the system is not capable of supplying such additional information to the emergency responders.

Accordingly, a need exists for an emergency response system that is capable of being used to supply emergency responders with additional information or otherwise to promote increased communication.

### SUMMARY

Certain aspects and embodiments of the present invention provide a method for generating a layered map of a geographic area. Pre-planning data that includes information associated with at least part of the geographic area is received. Map data that includes information on at least part of the geographic area is received. Current data is wirelessly requested from a server. The current data includes sensor data or position data of an emergency responder and is wirelessly received. A layered map is generated using the pre-planning data, map data, and current data. The layered map includes a representation of at least part of the geographic area. The layered map is outputted.

In some embodiments, geographic information for responding to an emergency event in a geographic area is provided. Sensor data is requested from a sensor located in the geographic area. The sensor data includes real-time information associated with a portion of the geographic area. The sensor data is wirelessly received in response to the request. Position data for a first user device is wirelessly received. The position data identifies a location of the first user device. A request for at least part of the sensor data or position data is received from a second user device. The sensor data or position data is wirelessly sent to the second user device in response to the request. The sensor data or position data can be incorporated into a layered map by the second user device.

In some embodiments, a system for use in responding to emergency events is provided. A first user device is provided with a mobile GIS engine, pre-planning data, and map data. The pre-planning data and map data includes information on a geographic area. At least one sensor is provided that is wirelessly coupled to a server. The sensor can provide sensor data to the server. A server is provided wirelessly coupled to the first user device. The server includes executable code stored on a computer-readable medium. The executable code includes a communication engine adapted to receive position data from a second user device and provide the position data and the sensor data to the first user device. The mobile GIS engine can generate a layered map using the pre-planning data, map data, and the sensor or the position data and output the layered map.

These embodiments are mentioned not to limit or define the inventive concepts disclosed herein, but to provide examples of embodiments to aid understanding thereof. Embodiments are discussed in the Detailed Description, and further description of the inventive concepts is provided there. Advantages offered by the various embodiments may be further understood by examining this specification.

### BRIEF DESCRIPTION OF THE APPLICATION DRAWINGS

These and other features, aspects, and advantages of the present invention are better understood when the following Detailed Description is read with reference to the accompanying drawings, wherein:

FIG. 1 is a block diagram of a geographic information system in accordance with one embodiment of the present invention;

FIG. 2 is a block diagram of a user device of a geographic information system in accordance with one embodiment of the present invention;

FIG. 3 illustrates a laptop user device in accordance with one embodiment of the present invention;

FIG. 4 illustrates a handheld user device in accordance with one embodiment of the present invention;

FIG. 5 is a block diagram of a second embodiment of a geographic information system.

FIG. 6 is a flow chart of a method for providing geographic information and current data in accordance with one embodiment of the present invention;

FIG. 7 is a flow chart of a method for generating a layered map at a user device in accordance with one embodiment of the present invention; and

FIGS. 8-17 are screen shots illustrating information provided by some embodiments of the present invention.

### DETAILED DESCRIPTION OF APPLICATION EMBODIMENTS

Some aspects and embodiments of the present invention provide emergency solutions that protect and assist first responders by combining: advanced client server software; Geographic Information System (GIS) technologies; complete communications interoperability; an exclusive low cost, spectrum-efficient, narrowband radio system; mobile units that operate independently or with any communications system; and downloadable software that facilitates cross-department collaboration.

Client/server environments, according to some embodiments, can operate with any wireless or available radio technology to display current data and facilitate collaboration—providing, for example, the exact location of responder vehicles every few seconds during an emergency. In addition, certain systems according to embodiments of the present invention are capable of displaying almost any form of information as it becomes available, including documents, streamed video, weather updates, and data from fixed, mobile, and remote sensors. This real-time information can be referenced with interactive map layers and embedded emergency response handbooks—available within an intuitive interface that can be easily learned and operated.

One aspect of certain embodiments is incorporating data from fixed, mobile, and remote GPS-equipped sensor devices. Nuclear or weather sensors can be deployed at the command post, in the field, or in responders' vehicles and configured to use any available spectrum. Once configured, some systems may automatically update sensor locations, providing immediate data on radiation, airborne contamination, and fall-back zones, which are often difficult to predict in shifting weather patterns.

In addition, systems according to embodiments of the present invention may be an emergency response solution in compliance with the Assure Emergency and Interoperable Communications for First Responders Act of 2005. Certain systems may combine new technology with seamless interoperability—with existing infrastructure, available radio frequencies, and all wireless technologies.

In some embodiments of the present invention, an emergency response information system is provided that can facilitate communication between emergency responders and a centralized dispatch office, command center, or other one or more centralized locations. The system can include: (1) a Geographic Information System (GIS) database that is adapted to store pre-planning data about specific locations within a geographic area, where the specific locations could potentially be a location of an emergency event, and map data that includes maps of a geographic area at various layers; (2) a communications server that is adapted to receive real-time data and provide the data to a user device that can generate a layered map using the real-time data, map data, and pre-planning data; and (3) one or more user devices that can receive the data from the communications server and provide an emergency responder with access to the data. The user device may be adapted to receive the data from the communications server via any communication medium and display the data to a mobile user, such as an emergency responder. In some embodiments, the mobile device may be adapted to receive a command from the mobile user and transmit information or a request for information in accordance with the command to the communications server. The communication medium may be any medium adapted to carry transmitted signals from a first point to one or more other points. Examples of a communication medium include air, such as for wireless communication, and wireline, including hardwire and optical fiber cables, or a combination thereof.

The database may also include additional data associated with potential emergency locations within a geographic area and personnel. The additional data can include any data pertinent to an emergency event or responding to an emergency event, in addition to pre-planning data and map data. Examples of additional data include a list of emergency responders available to respond to an emergency at a selected time, emergency responder vehicle location, educational information on hazardous material or emergency events, and current data. For example, the communications server may receive current data associated with one or more locations within a geographic area. In some embodiments, sensors, located within the geographic area, may receive and send current data to the communications server. The communications server can format and store the current data in a database. Examples of current data can include weather information and traffic information, or any observations of a geographic area.

An “emergency event,” as used herein includes any event associated with potential or actual emergency for which emergency responders are typically dispatched for the purposes of investigating, confirming, responding, controlling, distinguishing, and/or managing the emergency event. Examples of emergency events include fires, criminal acts that can include terrorist activities, accidents, health-related emergencies, chemical spills, natural disasters, and building damage and/or collapses.

Embodiments of the present invention may be used with existing or new emergency response infrastructure to provide increased communication capabilities for emergency responders who may respond to an emergency event. An example of a use of one embodiment of the present invention is to provide an emergency responder who is responding to a potential or actual fire at a location within a geographic area with information on a mobile device regarding the building that is the location of the fire and details associated with dangerous chemicals, liquids, or other gases stored therein, during the emergency responders trip to the location or after he or she arrives at the location.

Illustrative System Implementation

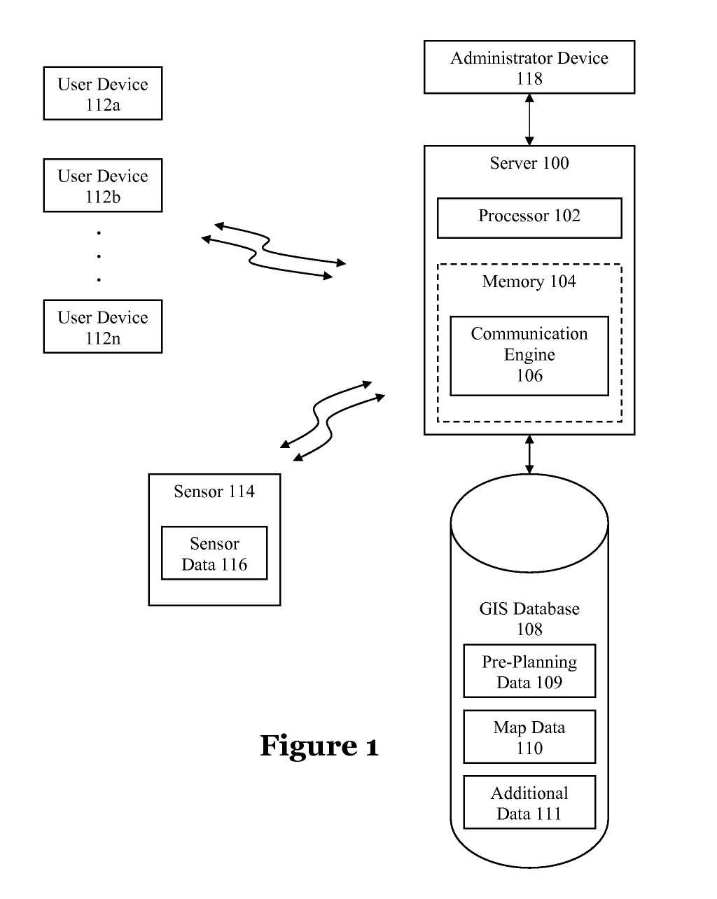

As stated above, embodiments of the present invention can be implemented on existing or new communication systems. FIG. 1 illustrates one embodiment of communication system for providing access to increased communication capabilities to emergency responders. The system in FIG. 1 includes a communications server, such as server 100. The server 100 includes a processor 102 and a computer-readable medium, such as memory 104. Memory 104 may be adapted to store computer-executable code and data. Examples of memory 104 can include magnetic disks, optical storage devices, floppy disks, hard disks, random access memory, semiconductor storage devices, and flash memory.

Computer-executable code may include an application, such as a data and communications management application, that can be used to manage data and communications. The application may include a communication engine 106 that, as described in more detail below, may be adapted to perform methods or portions of methods according to various embodiments of the present invention to manage data and communications. In some embodiments, the communication engine 106 may be a separate application that is executable separate from, and optionally concurrent with, the application.

The server 100 may be one or more servers that are adapted to provide functionality used in various embodiments of the present invention. For example, the server 100 may be two separate servers—a communications server adapted to communicate data to other devices, and a data server adapted to manage data, such as data acquisition, storage, and organization. The two separate servers may be adapted to communicate directly, or indirectly through another component, with each other.

In some embodiments, the server 100 may be in communication with an access device that can be used for server administration, and management purposes. The access device can include an input device and an output device that is adapted to allow an administrator, manager, or other command center personnel to input commands and receive information from the server 100. The input device may be adapted to receive access device user input and communicate the input to the server 100. Examples of an input device include a keyboard, mouse, scanner, network connection, and personal computer. Inputs can include commands that cause the processor 102 to execute various functions associated with the application or the communication engine 106. In some embodiments, the access device user may be required to supply authentication credentials to the server 100 via the input device before access to information and tools stored in the server 100 is granted. The server 100 may receive the credentials from the input device and access data in memory 104 or another location to determine if the credentials match stored credentials and to identify the access device user.

The output device may be adapted to provide data or visual output from the application or the communication engine 106. In some embodiments, the output device can display a visual representation of data and provide a graphical user interface (GUI) that includes one or more selectable buttons or other visual inputs that are associated with various functions provided by the application or the communication engine 106. Examples of an output device include a monitor, network connection, printer, and personal computer.

The server 100 may be in communication with one or more databases. One database may be a Geographic Information System (GIS) database 108. The server 100 may be adapted to request data from and send data to the GIS database 108. The GIS database 108 may include one or more different types of data associated with a geographic area. Examples of types of data that may be stored in GIS database 108 include pre-planning data 109, map data 110, and additional data 111. The server 100 may be adapted to communicate with the GIS database 108 directly or over a network such as an Internet or Intranet. In some embodiments, the server 100 includes the GIS database 108.

Pre-planning data 109 can include any data that may be available before an emergency event occurs on one or more locations within a geographic area. Examples of pre-planning data include building floor plans, building alarm information, building security information, such as the location of a spare entry key, locations of fire hydrants and other emergency response resources, other hydrant data, test records of such emergency response resources, land records, fire alarm information, hazardous material information, photographic records, site sketches, electrical diagrams, utility information, potential hazards, ownership information, response plan information, and incident history records.

Map data 110 can include any data associated with mapping a geographic area. In some embodiments, the map data 110 may be different types of map data or a collection of map data at different layers of a geographic area combined together to form a single map. Map data may be collected or generated from any source. Examples of sources include existing maps, Global Positioning System (GPS) data, aerial photography and other aerial mapping, and certain types of pre-planning data that may include mapping-related data such as utility grids, water and sewer systems, street center-line maps, and parcels.

Additional data 111 can include any data associated with a geographic area that is in addition to map data and pre-planning data. Examples of additional data include a list of emergency responders available to respond to an emergency at a selected time, emergency responder vehicle location, radiation levels, educational information on hazardous material or emergency events, embedded documents such as spreadsheets, floor plans, flow charts, photographs, and videos, and current data, such as current weather, chemical conditions, biological conditions, traffic conditions at one or more locations within the geographic area, or any real-time or substantially real-time data. Additional data 111 may be obtained from any source. Examples of sources for additional data 111 can include a network, such as an Internet or Intranet, remote sensors, other databases, manually entered data, and the emergency responders or devices used by the emergency responders.

The GIS database 108 may be one or more databases in communication with the server. For example, the GIS database 108 may include a pre-planning database that includes pre-plan data, a map database that includes map data, and an information database that includes additional data. Each database—pre-planning database, map database, and information database—may be a separate database that is in communication with the server 100 and, optionally, each of the other databases.

The server 100 may also be in communication with one or more user devices 112a-n. The user devices 112a-n may be used by emergency responders to receive information from the server 100 and, in some embodiments, communicate information back to the server 100. The user devices 112a-n may communicate with the server 100 via wireline and/or wireless connection. For example, the user devices 112a-n may be connected to the server via wireline to receive an application, such as a software application or tool, which is adapted to receive and display data from the server, and certain other types of data, such as pre-planning data and map data, that may be available. The user devices 112a-n may be used by emergency responders at a remote location relative to the server 100 to receive data from the server 100 via a wireless connection. The data received from the server 100 can include any type of information associated with an emergency event or responding to an emergency event. For example, the server 100 may be adapted to wirelessly send information about the location of the emergency event, weather information, traffic information, position data of other emergency responders, and/or certain types of pre-planning data.

In some embodiments, the user devices 112a-n are periodically connected to the server 100 via wireline and software updates and/or data updates or inputs are provided to the user devices 112a-n by the server 100. In some embodiments, the user devices 112a-n are initially loaded with pre-planning data and map data of a geographic area. The data updates can include updating the location and type of hazardous material in a geographic area. In other embodiments, the server 100 periodically or continuously sends software updates and/or data updates to the user devices 112a-n wirelessly. For wireless communication, the server 100 may be connected to an antenna via a transmitter and/or transceiver that is adapted to modulate data via a selected modulation technique and propagate it into a communication medium, such as air, for reception by the user devices 112a-n. The user devices 112a-n may be adapted to receive the transmitted data and, in some embodiments, transmit data or information queries to the server 100 via the antenna and transceiver.

Current data may be used in some systems according to various embodiments of the present invention to provide emergency responders with up-to-date information for responding to emergency events. Current data may include real-time data or substantially real-time data about a geographic area or portion of a geographic area. Current data is often difficult to obtain, particularly in emergency response systems, but can be valuable information for emergency responders during an emergency. In some embodiments of the present invention, one or more sensors, such as sensor 114, can be located in a geographic area to obtain at least some types of current data and send it to the server 100. The sensor 114 can be any type of sensor that can detect certain types of information, such as weather, traffic, or otherwise, and transmit the data to the server 100. In some embodiments, the sensor 114 may also store sensor data 116 locally. The sensor 114 may include a processor and an application that may be adapted to reformat data, determine data trends, or to otherwise organize and manipulate data detected by sensor 114. The application may be stored in computer-readable memory and executable by the processor. The server 100 may be adapted to receive sensor data via wireline or wireless connection and store the sensor data in its memory or GIS database 108. In some embodiments, the server 100 may wirelessly send the sensor data directly to one or more user devices 112a-n, automatically or upon a request for the data from one or more of the user devices 112a-n. In some embodiments, the current data can include position data of the user devices 112a-n.

Geographic information systems according to various embodiments of the present invention may use any wireless communication method to allow communication between system components such as server 100 and user devices 112a-n and/or server 100 and sensor 114. Examples of wireless communication methods include one or more IEEE 802 standards, satellite communications, and any radio frequency, infrared, or microwave communication technique, including techniques approved for the 220-222 MHz, 450 MHz, 700 MHz, 800 MHz, 900 MHz, and 2.4 GHz bands.

An administrator device 118 may be in communication with the server 100. The administrator device 118 may be used to access the communications engine 106 and receive or provide information, such as pre-planning data, map data, and additional data, such as current data. The administrator device 118 may be any device adapted to access the server and the communication engine 106. Examples of administrator device 118 include a processor-based device such as a computer. The administrator device 118 may be used to access information associated with a location corresponding to an emergency event and/or emergency responders. For example, the administrator device 118 may be used to access locations of emergency responders.

Illustrative User Devices

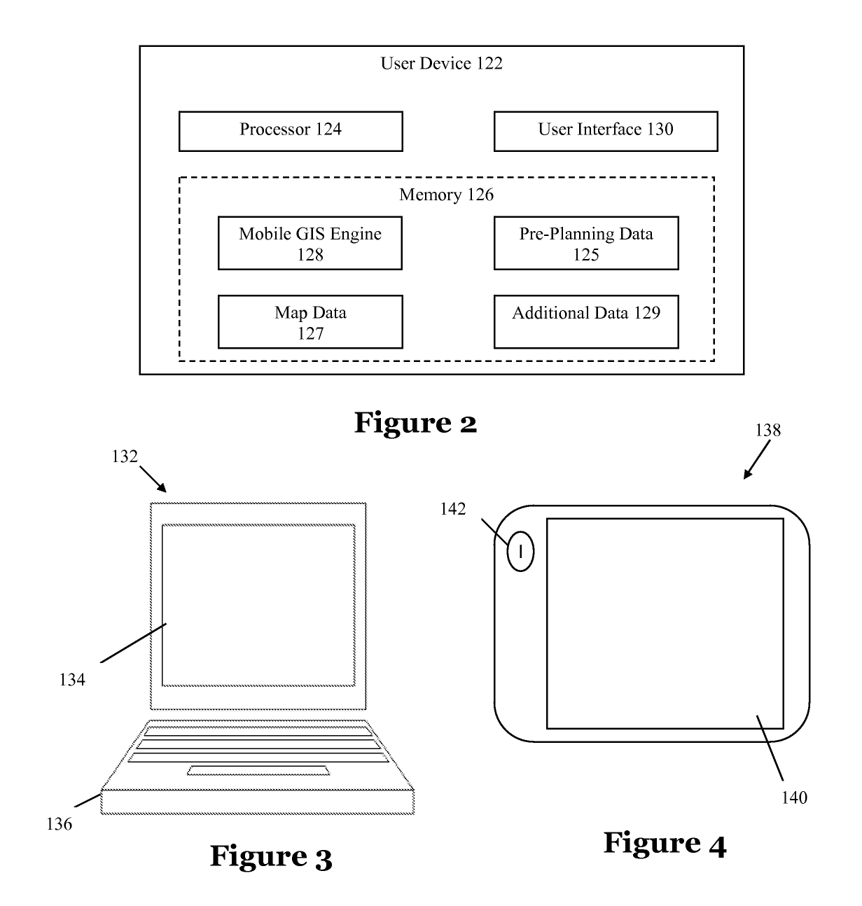

User devices according to various embodiments of the present invention may be any device that is adapted to receive and provide information to an emergency responder. FIG. 2 illustrates a block diagram of a user device 122 in accordance with one embodiment of the present invention. The user device 122 can include a processor 124 that is adapted to execute an application stored in a computer-readable medium, such as memory 126. The application may be, or can include, a mobile GIS engine 128 that is adapted to perform methods and other functions as described in more detail below, and provide an output to the user on a user interface 130. In some embodiments, the user device 122 includes a GPS or other mapping engine that is adapted to receive signals from a GPS or other mapping satellite and process the signals to provide the user with information. The mobile GIS engine 128 may be adapted to generate a comprehensive map that includes a combination of map data, pre-planning data, and, optionally, additional data. In some embodiments, the mobile GIS engine 128 receives a comprehensive map and is adapted to display it via the user interface 130. The user interface 130 may be a screen on which information is provided to the user. In some embodiments, the user device 122 includes an input with which users can input commands to the mobile GIS engine 128. The user device 122 may also include a receiver or transceiver and an antenna for communicating wirelessly with a server, such as server 100. The user device 122 can be connected to the receiver or transceiver and antenna.

Memory 126 may be adapted to store data received, via wireline or wirelessly, from the communication server 100 or another device. The stored data can include map data 127, pre-planning data 125, and additional data 129 associated with a geographic area. The user device 122 may also be adapted to receive data, wirelessly, from other devices, such as a global positioning system (GPS) satellite or terrestrial devices, in which the data received can be used to determine a location of the user device 122.

In some embodiments, the user devices are processor-based devices, such as user device 122, and housed in a casing that can be mounted to an emergency responder's vehicle or otherwise carried by the emergency responder. FIG. 3 illustrates a physical embodiment of a user device 132. User device 132 may be a computer, such as a laptop, that can be mounted to a vehicle and connected to an antenna via a receiver or transceiver. The user device 132 can include a user interface, such as a screen 134, that provides users with information and an input device, such as a keyboard 136, which can be used to provide commands or enter and request data.

FIG. 4 illustrates one embodiment of a handheld user device 138. The handheld user device 138 may be a relatively compact device that can be carried in an emergency responder's pocket or other article of clothing. The handheld user device 138 includes a user interface 140 that can provide the user with information and, in some embodiments, include technology that allows users to enter commands or otherwise request data by selecting buttons on the user interface 140. The handheld user device 138 may include a separate switch 142 that may be used to select certain functions, such as turning the handheld user device 138 on or off.

Other System Implementations

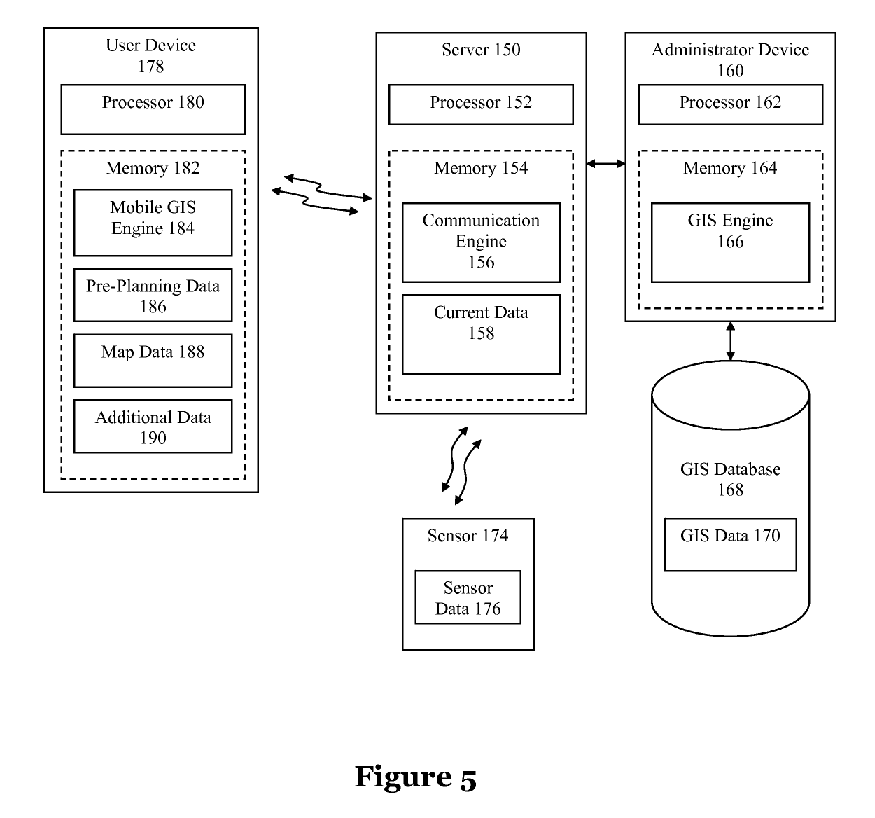

Various types of system implementations can be used to provide information associated with a geographic area in which an emergency event occurs to an emergency responder. FIG. 5 illustrates an alternative system implementation. The system includes a communications server, such as server 150, that includes a processor 152 and a computer-readable medium, such as memory 154. Memory 154 includes a communication engine 156 that may be adapted to manage, support, and/or perform communications between the server 150 and one or more user devices, such as user device 178. Memory 156 may also include current data 158 that can include current data received wirelessly from user devices or one or more sensors, such as sensor 174 that provides sensor data 176 associated with a portion of a geographic area.

The server 150 can be in communication with an administrator device 160 that can be used to configure or manage the server 150 and other communications. In some embodiments, the administrator device 160 is located at a command center. The administrator device 160 includes a processor 162 and a computer-readable medium, such as memory 164. Memory 164 can include a GIS engine 166 that is adapted to generate a layered map using GIS data 170 from a GIS database 168 and, in some embodiments, current data 158. The layered map can be outputted to a user interface and allow an administrator to view a visual representation of a geographic area or a portion of a geographic area. The GIS data 170 can include pre-planning data and map data that is provided to the GIS database 168 manually or automatically from a separate device.

The server 150 can communicate wirelessly with the user device 178 to receive position data associated with the user device. In some embodiments, the communication engine 156 receives sensor data 176 and position data, reformats the data, and stores in as communication data 158. The user device 178 includes a processor 180 and a computer-readable medium, such as memory 182. Memory 182 can include a mobile GIS engine 184 that is adapted to perform methods, or portions of methods, according to various embodiments of the present invention. Memory 182 can also include pre-planning data 186, map data 188, and additional data 190. In some embodiments, pre-planning data 186, map data 188, and additional data 190 are stored in one or more databases coupled to the user device 178.

Providing Geographic Information

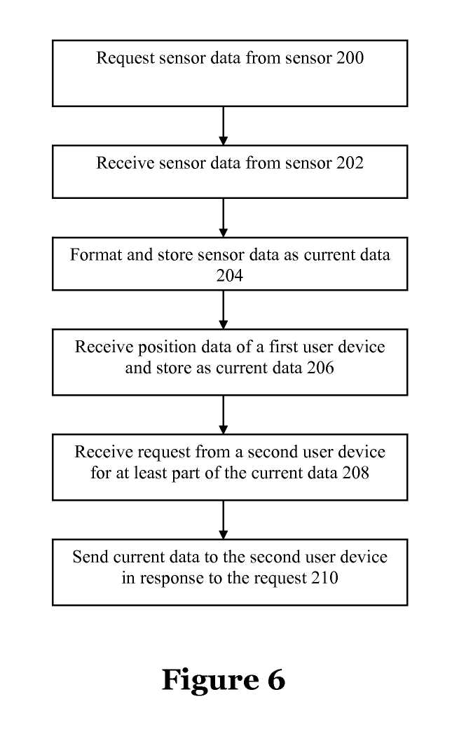

Various methods according to various embodiments of the present invention may be used to provide emergency responders with information to assist them in responding to emergency events. FIG. 6 illustrates one method for providing information to emergency responders in accordance with one embodiment of the present invention. For purposes of illustration only, the method of FIG. 6 is described with reference to the system shown in FIG. 1. Other system implementations are possible, such as the system shown in FIG. 5.

The method begins at block 200 when the server 100 provides a request for sensor data from sensor 114. The request can be transmitted wirelessly using any communication method to the sensor 114 and identifies the type of sensor data requested. Sensor data can include real-time or substantially real-time data associated with a geographic area or a portion of a geographic area. Examples of sensor data include weather information, traffic information, and chemical or biological information.

In block 202, the server 100 receives sensor data from the sensor 114. The sensor data can be received wirelessly from the sensor 114. The server 100 can format the sensor data into a selected format and/or store the sensor data in memory 104 or GIS database 108 as current data in block 204. In some embodiments, the sensor data 204 is alternatively stored in a separate database associated with the server 100. The sensor data can be reformatted before it is stored. For example, the sensor data can be formatted into Extensible Markup Language (XML) format before storing.

In block 206, the server 100 receives position data of one of the user devices 112a-n and stores the position data in memory 104 or GIS database 108 as current data. In some embodiments, the position data is alternatively stored in a separate database associated with the server. The position data may be a global positioning system (GPS) location identifying where the user device is located within the geographic area. In some embodiments, the server 100 receives position data for most or all of the user devices 112a-n. The position data can be reformatted before it is stored. For example, the position data can be formatted into Extensible Markup Language (XML) format before storing.

In block 208, the server 100 receives a request from a second user device for at least part of the current data. For example, the second user device may be associated with an emergency responder that is responding to an emergency event. The request may be for part of the current data for user devices other than the requesting user device. The request can be received wirelessly from the user device while, for example, the emergency responder is in route to an emergency event.

In block 210, the communication engine 106 uses the request to identify the current data and sends the identified current data to the requesting user device in response to the request. The current data may be sent wirelessly to the user device. In some embodiments, the current data is in a format that is adapted to be used by the second user device to generate a layered map that includes the current data.

Map Generation

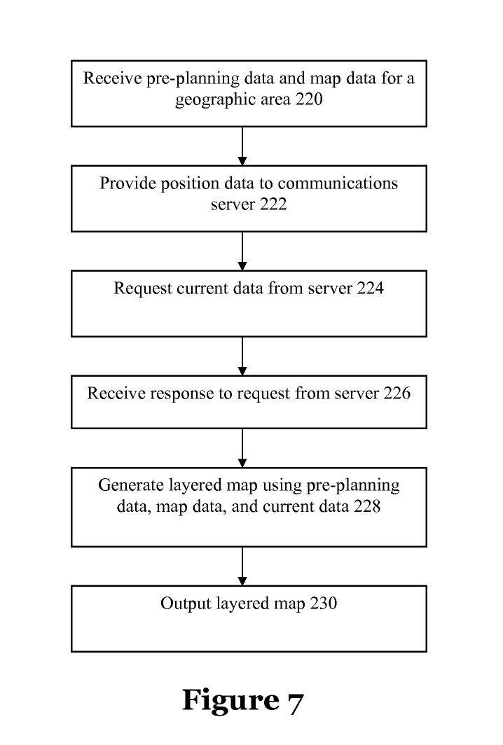

Layered maps or other displays can provide information to emergency responders and command center personnel in an easily readable format to assist them in responding to an emergency event. FIG. 7 illustrates one embodiment of using map data, pre-planning data, and current data to generate a layered map. The method shown in FIG. 7 is described with reference to the system in FIGS. 1 and 2. Other implementations, such as the system implementation illustrated in FIG. 5, are possible.

In block 220, a user device receives pre-planning data and map data for a geographic data. In some embodiments, the user device stores the pre-planning data and map data in memory or a database coupled to the user device. The user device may receive the pre-planning data and map data from any source and in any format. Examples of sources include the administrator device 118 and server 100. The administrator device can be used to configure the user device, upload pre-planning data and map data, and provide software or data updates. The server 100 or administrator device 118 can be connected via wireline or wirelessly with the user device to provide the pre-planning data and map data. An example of a format is a spatial format.

The pre-planning data may be any data that is generally available before an emergency event occurs regarding the geographic area and that may be relatively consistent data. Examples of pre-planning data include building floor plans, locations of fire hydrants and other emergency response resources, test records of such emergency response resources, land records, fire alarm information, and hazardous material information. Hazardous material information can include identification of hazardous material, the location of the hazardous material, and the amount of hazardous material. Examples of test records of emergency response resources include the water-pressure available at fire hydrants, date on which the resource was last tested, and any other characteristic available in a test report. Land records may include property boundaries, ownership history, and identification of current owner.

Examples of map data include digital and digitized maps, GPS data, aerial photography, and selected pre-planning data. Digital and digitized maps can include any type of map data, such as topography maps, contour maps, estate maps, geological maps, and street maps. Aerial photography can include aerial photographs digitized to provide mapping data and Geographical Information System (GIS) data. Selected pre-planning data can include any type of pre-planning data that may include spatial information associated with a geographic area. Examples of selected pre-planning data that may include spatial information include land records and building floor plans.

In some embodiments, the user device or administrator device 119 may be adapted to filter the data to remove any extraneous data, such as data associated with a location outside a geographic area of interest. The user device may also be adapted to organize the pre-planning data and/or map data before it is stored. For example, the user device may store map data as map attributes in a database and organize it by the type of map attributes and the geographic area associated with the map attributes. In some embodiments, the map data may be organized into two or more map categories. Examples of map categories include base map and thematic data. Each map category can include map attributes. For example, base map data can include (1) visible geography map attributes, such as building footprints, pavement edges, aerial photographic backdrops, roads, and creeks; (2) hydrology map attributes, such as location of water mains, fire hydrants, and underground aquifers; and (3) topography data map attributes, such as elevation information. Thematic data can include invisible geography map attributes, such as political line map data, including parcels, utilities, zoning, and special districts, such voting districts.

In block 222, the user device provides position data to the server 100. The position data may be a GPS or other location information identifying where the user device is located within the geographic area. The location of the user device can correspond to the location of an emergency responder associated with the user device and be sent wirelessly to the server 100.

In block 224, the user device sends a request for current data to the server 100. The request can include an identification of the type of current data requested by the user device. For example, the user device can request sensor data or a position of other user devices. The user device receives the requested current data wirelessly from the server 100 in block 226. The current data can be stored in a user device memory or a database coupled to the user device. In some embodiments, the user device receives the current data in a first format (such as XML) and reformats the current data into a second format (such as a spatial format) before storing.

In block 226, a mobile GIS engine 128 associated with the user device generates one or more layered maps using the pre-planning data, map data, and current data. Each layered map may spatially represent a layer of geographic information for a selected geographic area or at least a portion of a geographic area to create a model of map properties associated with the geographic area. In some embodiments, the layers include a two-dimensional and/or three-dimensional representation of the geographic area. The mobile GIS engine 128 may be adapted to access map data associated with a geographic area that have a common map attribute to generate a map layer. For example, one layer may include political line map attributes. In some embodiments, the mobile GIS engine 128 may combine different types of map attributes to generate a more comprehensive layered map that spatially illustrates a geographic area or at least a portion of a geographic area. The map layers may be generated using any method adapted to create a map of a geographic area spatially showing selected characteristics of the geographic area. Current data can be incorporated into the layered maps based on its location information and the type of information it represents. For example, if the current data includes positions of other user devices, the layered map can include an indicator representing the other user devices at the location from the current data.

In block 230, a layered map is outputted via the user interface 130 to the emergency responder. In some embodiments, the mobile GIS engine 128 can receive a command or other instruction from the emergency responder indicating the layers they wish to be outputted. The mobile GIS engine 128 can output the requested map layers. The outputted layered map can be displayed on an interface to the emergency responder.

The pre-planning data, map data, and current data may be used by emergency responders to effectively and quickly respond to an emergency event and to become aware of and educated on hazardous materials that may be located in or around an emergency event location. The pre-planning data, map data, and current data may also be used by administrators, such as dispatchers and other command center personnel, to determine the appropriate emergency responder personnel to dispatch to an emergency event or to otherwise manage the response strategy to the emergency event from a remote location. In some embodiments, the layered maps or other information generated using the pre-planning data, map data, and current data can be reviewed after a response to an emergency event is completed to identify areas for response improvement or to otherwise provide feedback information to emergency responders for training purposes.

User interfaces according to various embodiments of the present invention can include selectable options for displaying different types of information and information in different formats, such as maps having one or more layers. The types of information can include pre-planning data, layered maps generated using map data, current data, and positions of emergency responders currently dispatched or available for dispatch. The command center personnel can use the information to manage a response to an emergency event. The user device, via a device engine, may be adapted to display a user interface to an emergency responder. The device engine may use data stored locally on the user device and/or data wirelessly received from a server. In some embodiments, the device engine may reproduce the data as sound via a speaker or receive audio information and output it to the user via a speaker.

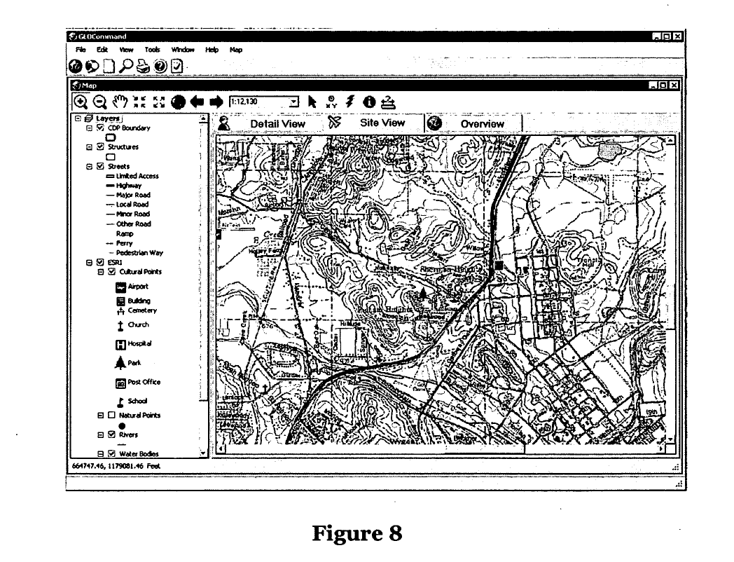

FIGS. 8-17 are screen shots showing examples of information displayed on user interfaces according to certain embodiments of the present invention. The screen shots may be displayed on an administrator device or a user device. The information on each screen shot may be generated from one or more of pre-planning data, map data, current data, and any other additional data associated with the emergency event.

FIG. 8 shows a customizable map of a geographic area in which an emergency event may be occurring at a particular location. The map is customizable in that users, whether emergency responders or administrators, can select the map layers to include on the map. Customizable maps allow for users to select the map layers relevant to a particular emergency event or geographic area. FIG. 8 shows layers that include land boundaries, structures, streets, cultural points, rivers, and water bodies. Other layers may be selected and displayed.

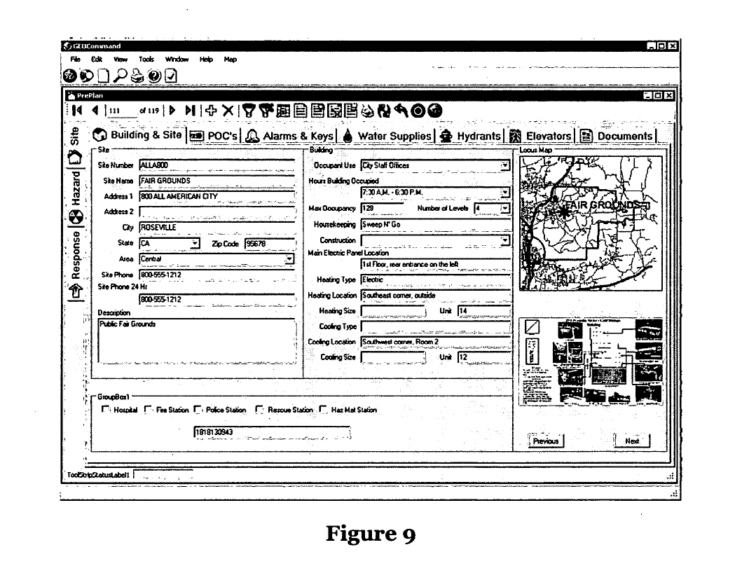

FIG. 9 shows information associated with an emergency event location. The information includes the address, description, use, maximum occupancy, and HVAC information for a building that may be a location of an emergency event. The information can be displayed to an administrator and/or an emergency responder.

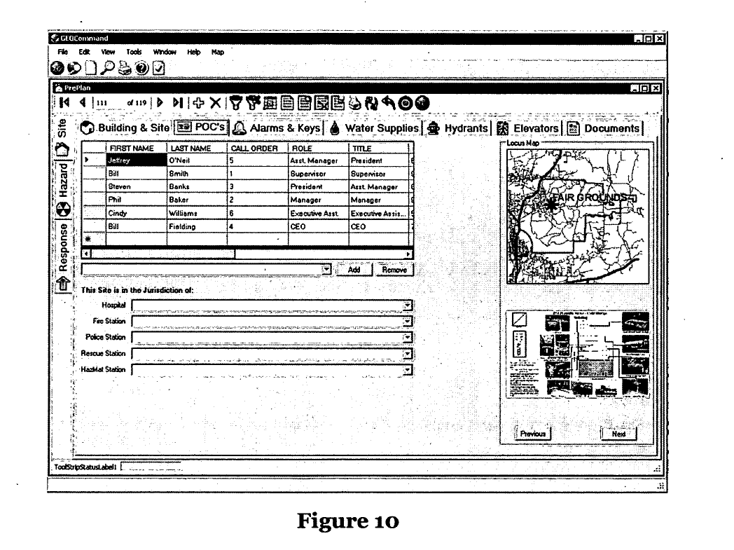

FIG. 10 shows a contact list of personnel or other personnel responsible for the building. The contact list can include a call order, indicating the order in which the personnel should be contacted in the event of an emergency. The contact list may be displayed to an administrator and/or an emergency responder.

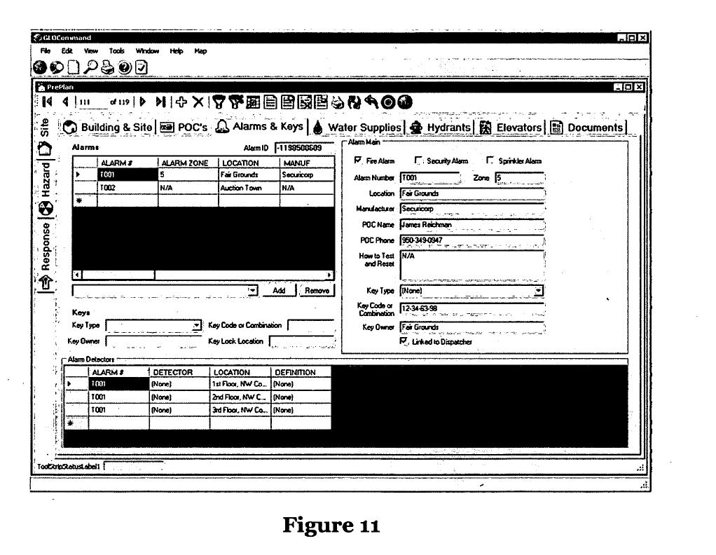

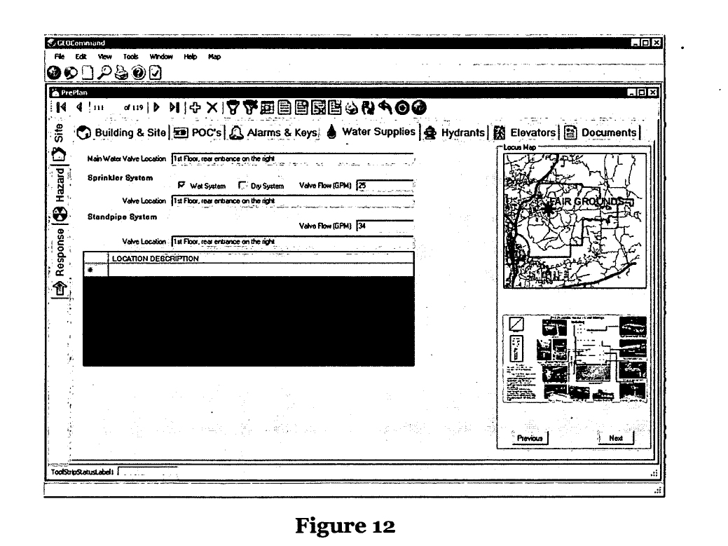

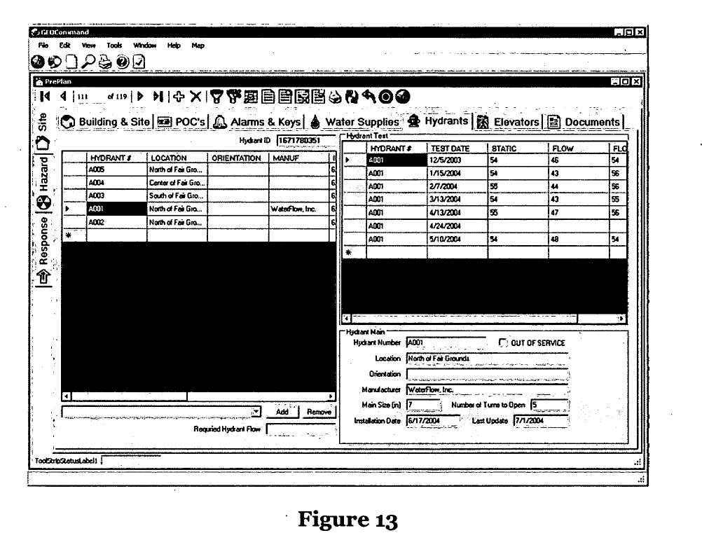

FIG. 11 shows alarm information associated with the building and information on how and where to disable the alarm or otherwise control it. FIG. 12 shows water information associated with the building, including the existence and control features of a sprinkler system within the building. FIG. 13 shows an identification and location of fire hydrant in or around the emergency event location. Additional information, such as test records information, may also be provided.

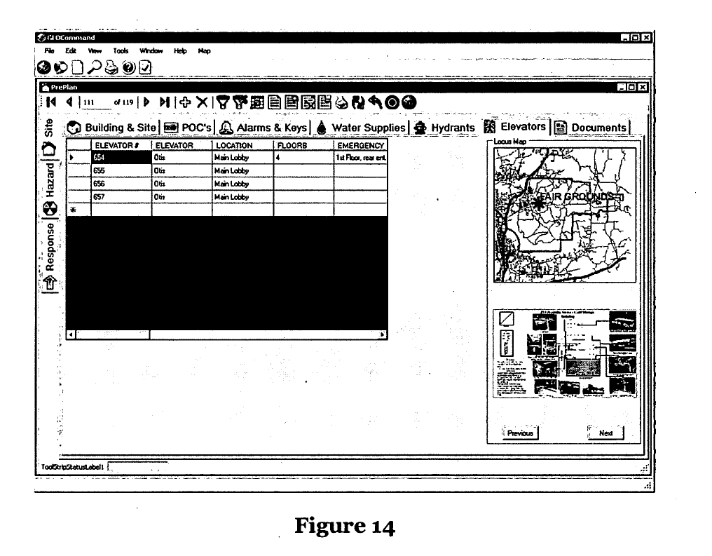

FIG. 14 shows an identification of elevators in the building at the emergency event location and associated information, such as location and floor access, regarding each elevator. If there are documents associated with the building or emergency event location, the documents tab can be selected to display such documents. The documents may include information concerning the emergency event site, such as the building's emergency plan, or directions for emergency responders on where to find people who have evacuated the building.

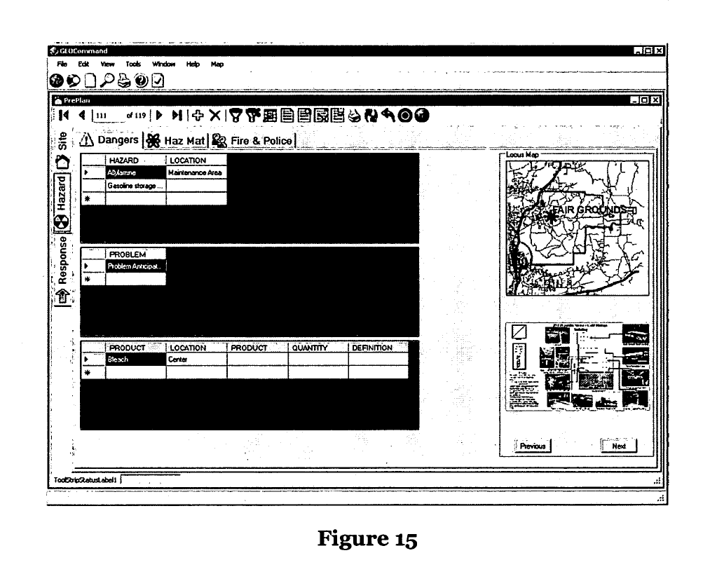

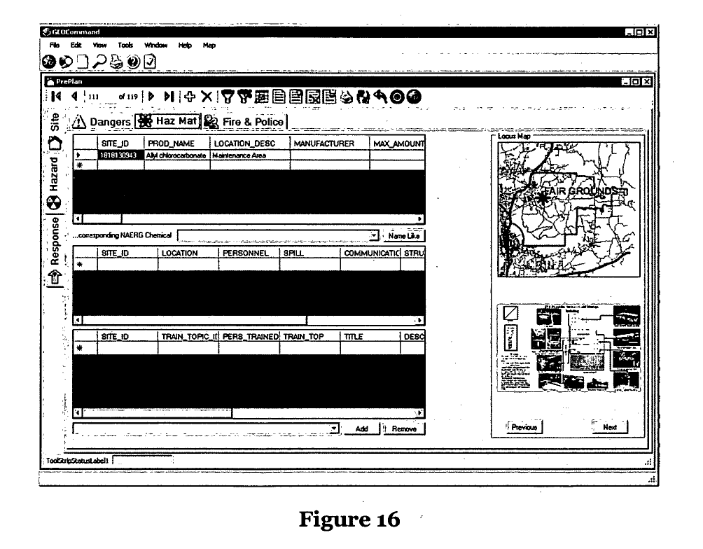

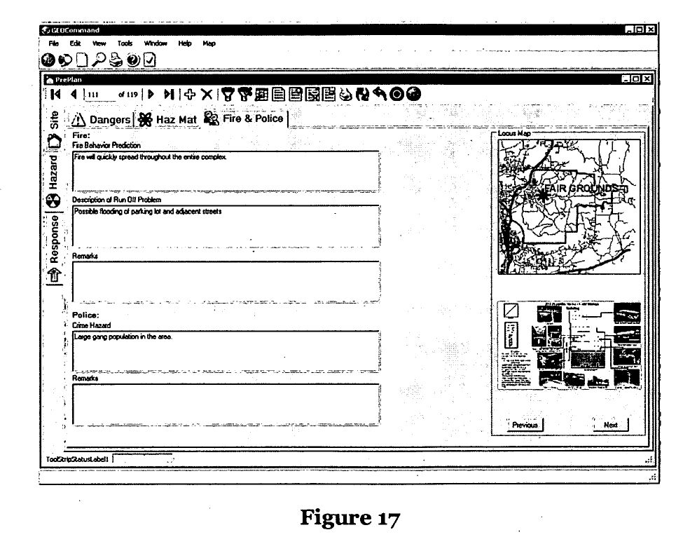

FIG. 15 shows potential dangers that may be located at or around the emergency event location. The potential dangers can include an identification and location of hazardous material on or around the location. FIG. 16 shows an identification and location of hazardous material on or around the location. In some embodiments, information concerning each hazardous material identified can be accessed and reviewed before responding to the emergency event. FIG. 17 shows pre-planned fire and/or police response issues that may be unique to the emergency event location. For example, the expected fire behavior at the location or population statistics can be provided to allow an emergency responder or administrator to decide the best strategy for responding to the emergency event.

### Illustrative Example

The following is an example of an implementation of one embodiment of the present invention. An emergency event occurs that includes a chemical spill at a toxic agent training facility. A command center receives a call reporting the emergency event. An administrator device is used to access the GIS engine and search for pre-planning data associated for the training facility. The training facility is selected on a map interface and one or more maps and selectable map attributes for the area surrounding and including the training facility can be generated for review for situational awareness. Current data associated with the geographic area surrounding and including the training facility is obtained from sensors located within or around the geographic area. The current data can include chemical and weather sensors providing chemical and weather characteristics associated with the environment of the geographic area of interest.

Emergency responders that include fire department personnel and emergency medical services personnel are dispatched to the training facility using any communication method. The location of emergency responder vehicles are tracked by receiving signals from user devices located in the vehicles. Additional current data is received indicating that a hazardous material emergency responder may be needed. The administrator can use the information to determine if different and additional emergency responders may be needed to respond to the emergency event. Hazardous material emergency responders are dispatched using any communication method. The server is used to send a message to the fire department and emergency medical service emergency responders indicating a dangerous chemical environment and provide an alternate route to avoid the chemical danger and reach at least a portion of the training facility to begin responding to the emergency event. In the interim, location information of the hazardous material team vehicles is tracked and communicated to the fire department and emergency medical service responders.

An emergency responder that has access to a user device inputs commands to obtain a map showing the training facility location as a destination, a preferred route to the training facility, and a location of fire hydrants or other response resources relative to the training facility. The user device may also be used to access pre-planning data, such as a building floor plan, training facility layout, location of hazardous material, and information associated with the particular hazardous material. The emergency responder can use the data to determine the best and quickest way to respond to the reported emergency event.

Certain embodiments of the present invention can be used to improve an emergency response infrastructure by allowing emergency responders to access information pertinent to responding to an emergency event. Examples of ways embodiments of the present invention can be used to improve responding to emergency events include finding fire hydrants closest to the emergency event location, finding fire hydrants with the highest water pressure, accessing a building floor plan of the building at the emergency event location, locating hazardous chemicals or other materials, determining chemicals in proximity to the emergency event, finding schools or other institutions that need to be evacuated, determining a “best” route to an emergency, and viewing an area surrounding a building at the emergency event. Certain embodiments of the present invention can be used in a training environment to simulate an emergency event and provide information with which emergency responders can improve preparedness.

The foregoing description of the embodiments of the invention has been presented only for the purpose of illustration and description and is not intended to be exhaustive or to limit the invention to the precise forms disclosed. Numerous modifications and adaptations are apparent to those skilled in the art without departing from the spirit and scope of the invention. Instead, reference should be made to the one or more claims hereinafter set forth.

What is claimed is:

1. A method for generating a layered map of a geographic area, the method comprising:
receiving pre-planning data and map data, the pre-planning data and map data comprising information associated with at least part of the geographic area;
wirelessly requesting current data from a server;
wirelessly receiving the current data, the current data comprising sensor data or position data of an emergency responder;
generating a layered map using the pre-planning data, map data, and current data, the layered map comprising a representation of at least part of the geographic area; and
outputting the layered map.

2. The method of claim 1, wherein sensor data comprises at least one of:
weather information associated with at least a portion of the geographic area;
traffic information associated with at least a portion of the geographic area;
chemical information associated with an environment within the geographic area; or
biological information associated with an environment within the geographic area.

3. The method of claim 1, wherein the pre-planning data comprises at least one of:
fire hydrant location;
building floor plan;
building alarm information;
building security information;
elevator location;
contact list;
hazardous material identification and location; or
information regarding hazardous material located in or around the emergency event location.

4. The method of claim 1, wherein the position data comprises a location of an emergency responder vehicle in route to the emergency event.

5. The method of claim 1, further comprising providing an administrator with access to the pre-planning data, plurality of layered maps, and current data.

6. The system of claim 1, wherein the map data comprises at least one of:
digital or digitized maps;
Global Positioning System (GPS) data; or
aerial photography.

7. A method for providing geographic information for responding to an emergency event in a geographic area, the method comprising:
requesting sensor data from a sensor located in the geographic area, the sensor data comprising real-time information associated with a portion of the geographic area;
wirelessly receiving the sensor data in response to the request;
wirelessly receiving position data for a first user device, the position data identifying a location of the first user device;
wirelessly receiving a request for at least part of the sensor data or position data, the request being received from a second user device; and
wirelessly sending sensor data or position data to the second user device in response to the request,
wherein the sensor data or position data is adapted to be incorporated into a layered map by the second user device.

8. The method of claim 7, wherein sensor data comprises at least one of:
weather information associated with at least a portion of the geographic area;
traffic information associated with at least a portion of the geographic area;
chemical information associated with an environment within the geographic area; or
biological information associated with an environment within the geographic area.

9. The method of claim 7, further comprising:
formatting the sensor data and position data into an Extensible Markup Language (XML) format; and
storing the sensor data and position data.

10. A system for use in responding to emergency events, the system comprising:
a first user device comprising a mobile GIS engine, pre-planning data, and map data, the pre-planning data and map data comprising information on a geographic area;
at least one sensor wirelessly coupled to a server, the at least one sensor adapted to provide sensor data to the server; and
a server wirelessly coupled to the first user device, the server comprising executable code stored on a computer-readable medium, the executable code comprising a communication engine adapted to receive position data from a second user device and provide the position data and the sensor data to the first user device,
wherein the mobile GIS engine is adapted to:
generate a layered map using the pre-planning data, map data, and at least one of the sensor data or the position data; and
output the layered map.

11. The system of claim 10, wherein the layered map comprises a plurality of layers, each of the plurality of layers representing part of the geographic area.

12. The system of claim 10, further comprising a transceiver coupled to the server, wherein the transceiver is adapted to wirelessly communicate with the user device and the at least one sensor.

13. The system of claim 10, wherein current data comprises at least one of:
weather information associated with at least a portion of the geographic area;
traffic information associated with at least a portion of the geographic area;
chemical information associated with an environment within the geographic area; or
biological information associated with an environment within the geographic area.

14. The system of claim 10, wherein the pre-planning data comprises at least one of:
fire hydrant location;
building floor plan;
building alarm information;
building security information;
elevator location;
contact list;
hazardous material identification and location; or
information regarding hazardous material located in or around the emergency event location.

15. The system of claim 10, further comprising:
an administrator device coupled to the server, the administrator device comprising a GIS engine adapted to:
generate a layered map using the pre-planning data, map data, and current data; and
output the layered map for display to an administrator.

16. The system of claim 10, wherein the map data comprises at least one of:
digital or digitized maps;
Global Positioning System (GPS) data; or
aerial photography.

17. The system of claim 10, wherein the communication engine is adapted to:
format the sensor data and position data into an Extensible Markup Language (XML) format; and
store the sensor data and position data.

18. A computer-readable medium on which is program code, the computer-readable medium comprising;
program code for receiving pre-planning data and map data, the pre-planning data and map data comprising information associated with at least part of the geographic area;
program code for wirelessly requesting current data from a server;
program code for wirelessly receiving the current data, the current data comprising sensor data or position data of an emergency responder;
program code for generating a layered map using the pre-planning data, map data, and current data, the layered map comprising a representation of at least part of the geographic area; and
program code for outputting the layered map.

19. The computer-readable medium of claim 18, wherein sensor data comprises at least one of:
weather information associated with at least a portion of the geographic area;
traffic information associated with at least a portion of the geographic area;
chemical information associated with an environment within the geographic area; or
biological information associated with an environment within the geographic area.

20. The computer-readable medium of claim 18, wherein the pre-planning data comprises at least one of:
fire hydrant location;
building floor plan;
building alarm information;
building security information;
elevator location;
contact list;
hazardous material identification and location; or
information regarding hazardous material located in or around the emergency event location.

21. The computer-readable medium of claim 18, wherein the map data comprises at least one of:
digital or digitized maps;
Global Positioning System (GPS) data; or
aerial photography.
